(19) United States
(12) Patent Application Publication
(10) Pub. No.: US 2011/0030036 A1
(43) Pub. Date: Feb. 3, 2011

(54) RUNNING A SOFTWARE MODULE AT A HIGHER PRIVILEGE LEVEL IN RESPONSE TO A REQUESTOR ASSOCIATED WITH A LOWER PRIVILEGE LEVEL

(76) Inventor: James W. Wells, JR., Roseville, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/533,057

(22) Filed: Jul. 31, 2009

(51) Int. Cl. H04L 29/06; G06F 12/14

(52) U.S. Cl. 726/4; 711/216

(57) ABSTRACT

A request is received from a requester to run a first software module at a first privilege level, where the requester is associated with a second privilege level, and wherein the first privilege level is higher than the second privilege level. It is determined whether the first software module is valid to run at the first privilege level by checking for predefined content associated with the first software module. The first software module is run at the first privilege level on the computer in response to detecting the predefined content.

### BACKGROUND

Software modules can be provided in a computer to perform various tasks. One example type of software module is a script, which is a text file that contains a sequence of commands to be executed by an operating system or other software of the computer. Scripts can be written to perform any number of different tasks.

In some cases, it is desirable that scripts perform relatively sensitive tasks within a computer. One example of such a script is a script called by a non-privileged user to perform a software auto-update or self-update on a computer. Often, to perform such sensitive tasks in a computer, a script has to run at a relatively high privilege level in the computer, but the non-privileged user may not have such privileges. One such high privilege level is the root privilege level, administrator privilege level, or some other relatively high privilege level that some users have but other users do not. However, the ability to run a script at a relatively high privilege level creates a security hole that may be exploited by malicious software or hackers.

### BRIEF DESCRIPTION OF THE DRAWINGS

Some embodiments of the invention are described with respect to the following figures:

FIG. 1 is a block diagram of an exemplary computer that incorporates an embodiment of the invention;

FIG. 2 is a flow diagram of a general process of running a utility script at a higher privilege level, in accordance with an embodiment;

FIG. 3 is a flow diagram of a general process of running a utility script at a higher privilege level, according to another embodiment;

FIG. 4 is a flow diagram of a process performed by a utility script, according to an embodiment; and

FIG. 5 is a flow diagram of a process performed by a secure program to execute the utility script at a higher privilege level, according to an embodiment.

### DETAILED DESCRIPTION

In some cases, it is desirable to allow a non-privileged requester (such as a user, software application, or other entity) to run a software module at a higher privilege level. A “higher privilege level” refers to a level of software execution where the software has relatively high access and/or execution rights. As noted above, examples of a higher privilege level include one or more of the following: a root privilege level, an administrator privilege level, or some other relatively high privilege level that some users have but other users do not. A “non-privileged level” is one that is associated with a lower access and/or execution rights. In one example, it may be desirable to allow a non-privileged user to install a software update in a computer, where the software update is performed by the software module running at a higher privilege level. Allowing a non-privileged user to run a software module at a higher privilege level may expose security holes that can be exploited by malicious software. For example, a hacker into the computer may modify the software module such that when the modified software module is executed at the higher privilege level, malicious content or software instructions may be loaded into the computer. In another example, it may be desirable to allow a non-privileged user to make specific changes to the computer (for example, updating certain firewall settings). In this case, the non-privileged user would only be given the privileges to modify the specific firewall settings that they are allowed to modify.

In accordance with some embodiments, to address the foregoing security issue, the software module is executed at the higher privilege level in response to a validity check performed by a secure program. The validity check performed by the secure program involves checking for predefined content associated with the software module. In one embodiment, the predefined content is a hash that is calculated by applying a hash function on the content of the software module (which can be the entire content of the software module or some portion of the software module). The calculated hash is compared with a protected predefined hash that is available to the secure program. If the calculated hash matches the predefined hash, then the validity check passes, and the secure program allows the software module to run at the higher privilege level. On the other hand, if the calculated hash does not match the predefined hash, then the secure program returns an error and prevents the software module from executing at the higher privilege level.

In some embodiments, the software module that can be run at the higher privilege level is a utility script to perform predefined utility tasks in a computer. One example of such a utility task is software update installation. Another example is firewall configuration. There are many different specific utility tasks that may be performed at a higher privilege level without having to define new, limited OS-specific privileges when some embodiments of the invention are employed.

A “script” refers to a software program or sequence of instructions that is interpreted by another software program. More specifically, a script refers to a text file that contains a sequence of commands to be executed by an operating system or other software of the computer. This is contrasted to software programs that have to be first compiled into object code before the object code can be executed. However, although the ensuing discussion refers to techniques for determining whether or not a utility script can be executed at a higher privilege level, it is noted that such techniques can also be applied to other types of software modules, including software modules that are first compiled before being executed. An example of this would be a compiled software module that may almost entirely be run as a non-privileged user, but has to have higher privileges for some of its functions. Rather than granting higher privileges to all of the compiled software functions, a technique according to some embodiments allows higher privileges to be granted only for the specific functions for which higher privileges are to be assigned, which enhances the security of the compiled software module.

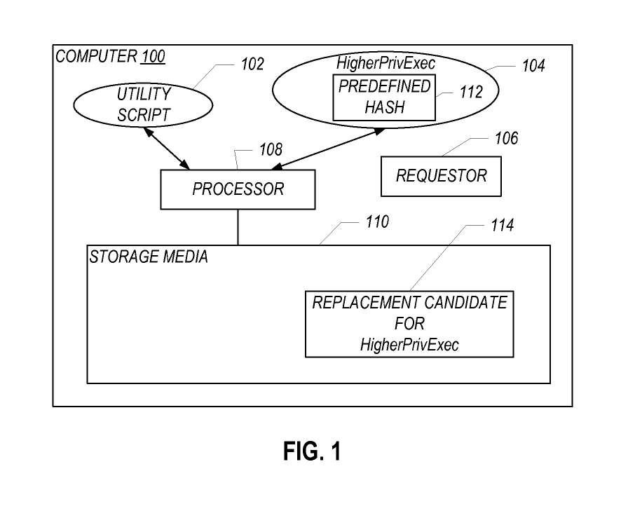

FIG. 1 illustrates an example computer 100 that includes a utility script 102 and a HigherPrivExec module 104, which is an example of the secure program discussed above for executing the utility script 102 at a higher privilege level even though a requester 106 who has requested execution of the utility script 102 at the higher privilege level does not have that privilege. In some implementations, the HigherPrivExec module 104 has its setuid (which is short for set user ID) flag set to allow the HigherPrivExec module 104 to execute at an elevated privilege level, which in one example is the root privilege level. By having its setuid flag set, the HigherPrivExec module 104 can effectively run the utility script 102 at the root privilege level for users that belong to specified groups. The setuid flag is considered to be an access rights flag that when set allows an executable to be run at a higher privilege level. In other implementations, the HigherPrivExec module 104 is a daemon or service that is continuously running at an elevated privilege level or is an executable that is marked by the operating system to run at an elevated level.

As further shown in FIG. 1, the HigherPrivExec module 104 contains a predefined hash 112 that is used by the HigherPrivExec module 104 to determine whether the utility script 102 is a valid script for execution at the higher privilege level. In some implementations, HigherPrivExec module 104 is compiled with the predefined hash 112 built into the HigherPrivExec module 104.

The utility script 102 and HigherPrivExec module 104 are executable on a processor 108 in the computer 100, which is connected to a storage media 110. The storage media 110 can be implemented with one or more disk-based storage devices and/or one or more integrated circuit or semi-conductor memory devices. As shown in FIG. 1, the storage media 110 can be used to store a replacement candidate 114 for the HigherPrivExec module 104-a secure technique of replacing the HigherPrivExec module 104 with the replacement candidate 114 is discussed further below.

The requestor 106 represents either a user interface to receive a request from a user, or alternatively, a software application that can request execution of the utility script 102 at a higher privilege level to perform desired tasks in the computer 100.

Examples of the computer 100 include a desktop computer, a portable computer, a server computer, a smart phone, a personal digital assistant (PDA), an appliance, or any other type of electronic device. The computer 100 also includes an operating system (not shown), which can be a Unix operating system or Linux operating system. In other implementations, the computer 100 can include a WINDOWS operating system.

Although reference is made to the HigherPrivExec module 104 in the present discussion, it is noted that techniques according to some embodiments can be applied for use with other types of secure programs.

More generally, in response to a request to execute the utility script 102 at a first privilege level from the requestor 106 that has a privilege at a second privilege level that is lower than the first privilege level, the HigherPrivExec module 104 (or other secure program) checks to determine whether the utility script 102 is associated with predefined content, and if so, the HigherPrivExec module 104 (or other secure program) executes the utility script 102 at the first privilege level. However, if the utility script 102 is not associated with predefined content, then the HigherPrivExec module 104 (or other secure program) does not execute the utility script 102 at the first privilege level.

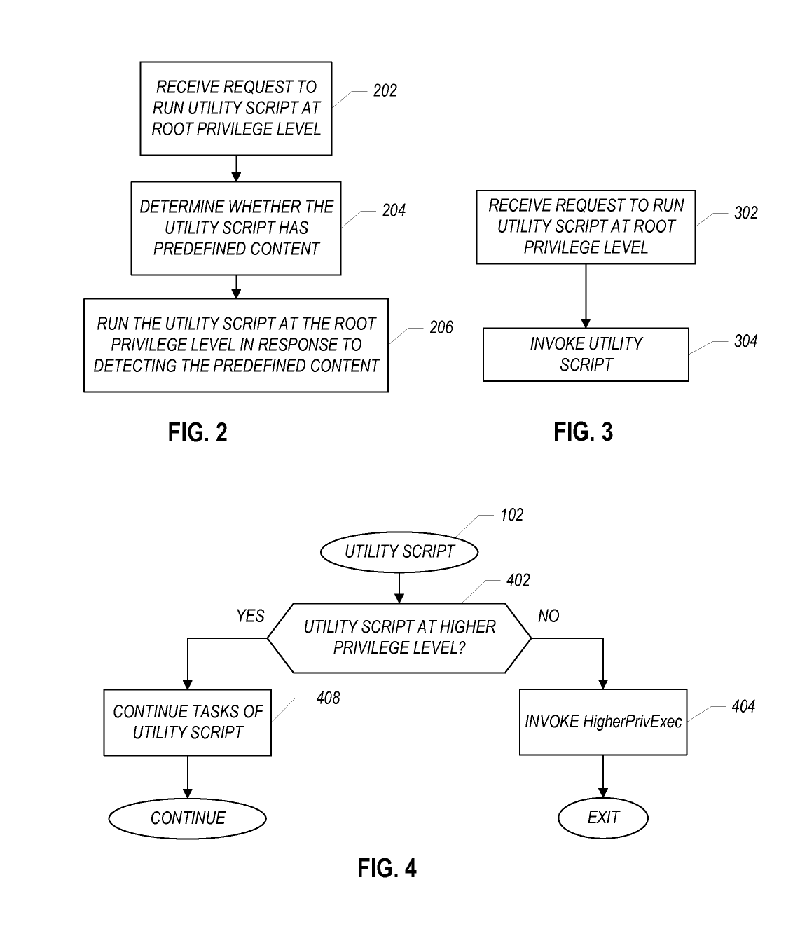

FIG. 2 is a flow diagram of a general process according to an embodiment. A request is received (at 202) from a non-privileged requester 106 (FIG. 1) to run the utility script 102 at a higher privilege level. In response to the request, it is determined (at 204) whether the utility script 102 has predefined content (e.g., a hash calculated based on content of the utility script 102 matches a predefined hash 112). The utility script is run (at 206) at the higher privilege level in response to detecting the predefined content. If the predefined content is not detected, then the utility script is not allowed to run at the higher privilege level.

FIG. 3 illustrates an alternative embodiment for running the utility script 102 at a higher privilege level. In response to receiving (at 302) a request to run the utility script at a higher privilege level, the utility script 102 is invoked (at 304). In this embodiment, the utility script 102 contains code that invokes the HigherPrivExec module 104 to determine whether or not the utility script can be run at the higher privilege level.

FIG. 4 illustrates tasks performed by the utility script 102 according to an embodiment. The utility script 102 checks (at 402) whether the utility script 102 is at the higher privilege level. If the utility script 102 is already at the higher privilege level, then the tasks of the utility script 102 can be performed (at 408).

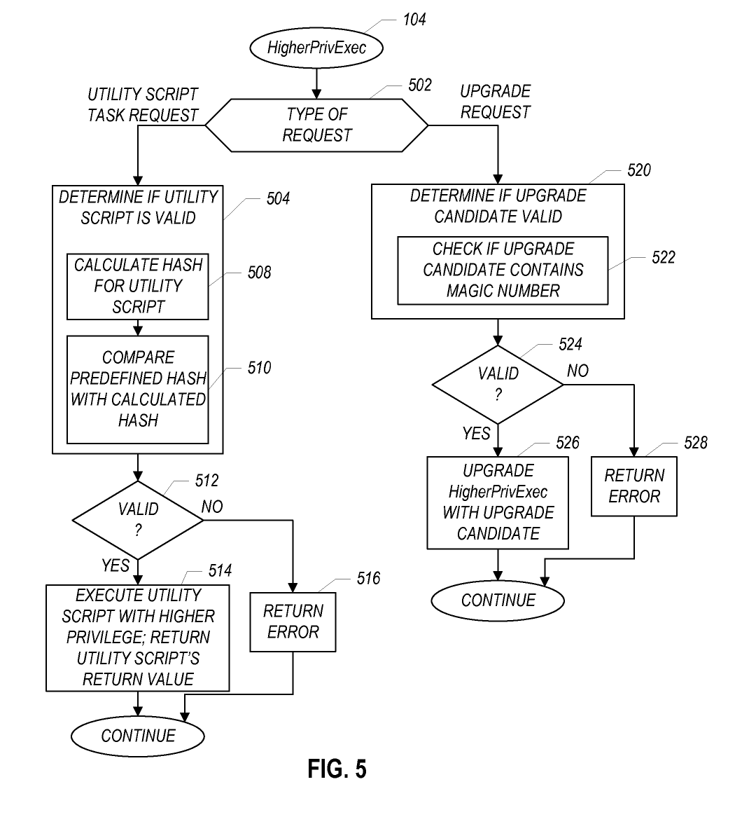

However, if the utility script 102 is not yet at the higher privilege level, the utility script 102 invokes (at 404) the HigherPrivExec module 104. The HigherPrivExec module 104 performs the tasks depicted in FIG. 5, which include re-executing the utility script 102 at a higher privilege, if it passes the content criteria (in other words, a hash calculated for the utility script matches the predefined hash 112 of FIG. 1). The utility script 102 returns as its exit code whatever the HigherPrivExec module 104 returns as its exit code.

FIG. 5 is a flow diagram of a process performed by the HigherPrivExec module 104 in response to a request to invoke the HigherPrivExec module 104. Upon invocation, the HigherPrivExec module 104 determines (at 502) the type of request that has been received. The request can be a utility script task request. In response to receiving the utility script task request, the HigherPrivExec module 104 determines (at 504) if the utility script 102 is valid. This determination includes the HigherPrivExec module 104 calculating (at 508) a hash for the utility script (by applying a hash function on content of the utility script 102), and comparing (at 510) the calculated hash with the predefined hash 112 that has been compiled into the HigherPrivExec module 104 as discussed above.

The HigherPrivExec module 104 then determines (at 512) whether a result of the comparison indicates that the utility script 102 is valid. If so, then the HigherPrivExec module 104 executes (at 514) the utility script 102 at the higher privilege level. The exit code of the utility script 102 running at a higher privilege level is returned to the HigherPrivExec module 104, which in turn returns it to the non-privileged utility script 102 that called it, which in turn returns it to the non-privileged requestor 106.

However, if the HigherPrivExec module 104 determines (at 512) that the comparison of the predefined hash with the calculated hash indicates that the utility script 102 is not valid (because the calculated hash does not match the predefined hash), then the HigherPrivExec module 104 returns (at 516) an error (failure exit code), which the utility script 102 returns as its exit code.

More specifically, the HigherPrivExec module 104 imbues the utility script 102 with its own higher level privilege(s). In one embodiment, the HigherPrivExec module 104 gains its higher privilege(s) because the HigherPrivExec module 104 has its setuid flag set. In other embodiments, the HigherPrivExec module 104 gains its privilege(s) because the HigherPrivExec module 104 is a service or a daemon already running at a higher privilege level, or an executable that the operating system knows to run at a higher privilege level through some other mechanism.

In accordance with further embodiments, a mechanism is also provided to allow the HigherPrivExec module 104 to upgrade itself with a new HigherPrivExec module that has been modified with respect to the previous version of the HigherPrivExec module. In FIG. 1, this new HigherPrivExec module is depicted as a replacement candidate for HigherPrivExec (114). An upgrade request can be submitted to the HigherPrivExec module 104 to cause the HigherPrivExec module 104 to upgrade itself with the replacement candidate 114. This functionality is provided to allow a non-privileged requester to upgrade the HigherPrivExec module 104 without the privileges provided by the HigherPrivExec module.

In response to the upgrade request, as determined at 502, the HigherPrivExec module 104 determines (at 520) if the replacement candidate 114 is valid. This check is performed to ensure that a hacker or malicious software does not provide an unauthorized replacement candidate for the HigherPrivExec module. Determining if the upgrade candidate 114 is valid involves checking (at 522) if the upgrade candidate 114 contains a predefined sequence of bytes or other predefined pattern (referred to here as a “magic number”).

In some embodiments, in addition to checking if the upgrade candidate 114 contains a magic number, the HigherPrivExec module 104 can also pass a random argument to the replacement candidate 114, which then performs a calculation on the random argument and returns back a string. The HigherPrivExec module 104 performs the same calculation and determines whether the result calculated by the existing HigherPrivExec module 104 matches the calculation performed by the replacement candidate 114. If the results match, then the replacement candidate 114 is considered to be valid. However, if the results do not match, then the replacement candidate 114 is considered to be invalid.

The HigherPrivExec module 104 next determines (at 524) if the replacement candidate 114 is valid based on checking performed at 522. If the replacement candidate 114 is valid, then the HigherPrivExec module 104 upgrades (at 526) itself with the replacement candidate 114.

However, if the replacement candidate 114 is not valid, as determined at 522, then the HigherPrivExec module 104 returns (at 528) an error and prevents the upgrade from occurring.

By being able to securely upgrade itself as described above upon request by a non-privileged requester without a complex upgrade mechanism, flexibility and convenience is enhanced since the HigherPrivExec module 104 can be easily updated.

Also, by employing a mechanism according to some embodiments to allow for utility scripts to be executed at a higher privilege level by a non-privileged requester, more flexibility is provided for manufacturers of computers. Such utility scripts can be provided with the computers, or can be subsequently sent to the computers, to allow desired tasks to be performed at the computers after the computers have been delivered to end users. As noted above, one example of such desired tasks includes installation of software updates.

Instructions of software described above (including the utility script 102 and HigherPrivExec module 104 of FIG. 1) are loaded for execution on a processor (such as processor 108 in FIG. 1). The processor includes microprocessors, microcontrollers, processor modules or subsystems (including one or more microprocessors or microcontrollers), or other control or computing devices. As used here, a “processor” can refer to a single component or to plural components (e.g., one or more CPUs).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs). Note that the instructions of the software discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method comprising:
receiving, from a requester, a request to run a first software module at a first privilege level, wherein the requester is associated with a second privilege level, wherein the first privilege level is higher than the second privilege level;
determining, by a computer, whether the first software module is valid to run at the first privilege level by checking for predefined content associated with the first software module; and
running the first software module at the first privilege level on the computer in response to detecting the predefined content.

2. The method of claim 1, wherein the determining is performed by a second software module running at the first privilege level.

3. The method of claim 2, further comprising:
the second software module executing the first software module at the first privilege level.

4. The method of claim 1, wherein running the first software module at the first privilege level comprises running a utility script at the first privilege level.

5. The method of claim 1, wherein receiving the request from the requester associated with a second privilege level comprises receiving the request from the requester that is one of a user and a software entity.

6. The method of claim 1, wherein checking for the predefined content comprises calculating a hash based on content of the first software module and comparing the calculated hash against a predefined hash.

7. The method of claim 6, further comprising:
in response to determining that the calculated hash does not match the predefined hash, output an error and prevent running the first software module at the first privilege level.

8. The method of claim 6, wherein the comparing is performed by a second software module, and wherein the predefined hash is compiled into the second software module.

9. The method of claim 1, wherein the determining is performed by a second software module that is configured to execute the first software module at the first privilege level, the method further comprising:
receiving a request to update the second software module with a replacement candidate for the second software module;
in response to the request to update, determining whether the replacement candidate is valid; and
in response to determining that the replacement candidate is not valid, preventing the update of the second software module with the replacement candidate.

10. The method of claim 9, wherein determining whether the replacement candidate is valid comprises determining whether the replacement candidate contains a predefined pattern.

11. A computer comprising:
a processor to:
use a secure program to execute a software module at a first privilege level in response to a request to execute the software module at the first privilege level, wherein the request is from a requester associated with a second privilege level lower than the first privilege level, and
in response to a request to update the secure program with a replacement candidate of the secure program, update the secure program if a validity check indicates that the replacement candidate is valid.

12. The computer of claim 11, wherein the secure program is configured to calculate a value based on content of the software module, wherein the software module is executable at the first privilege level in response to determining that the calculated value matches a predefined value.

13. The computer of claim 12, wherein the calculated value is a calculated hash, and the predefined value is a predefined hash.

14. The computer of claim 11, wherein the validity check includes determining whether the replacement candidate contains a predefined pattern.

15. The computer of claim 11, wherein the software module is a script to perform a software update in the computer.

16. The computer of claim 11, wherein the software module is configured to invoke the secure program in response to the request.

17. An article comprising at least one computer-readable storage medium containing instructions that upon execution cause a computer to:
receive, from a requester, a request to run a first software module at a higher privilege level, wherein the requester is associated with a second privilege level lower than the higher privilege level;
determine whether the first software module is valid to run at the higher privilege level by checking for predefined content associated with the first software module; and
run the first software module at the higher privilege level on the computer in response to detecting the predefined content.

18. The article of claim 17, wherein the instructions upon execution cause the computer to further:
calculate a hash based on content of the first software module,
wherein checking for the predefined content comprises comparing the calculated hash to the predefined content, and
wherein running the first software module at the higher privilege level is in response to the calculated hash matching the predefined content.

19. The article of claim 17, wherein the determining is performed by a second software module that is configured to execute the first software module at the higher privilege level, the instructions upon execution causing the computer to further:
receive a request to update the second software module with a replacement candidate for the second software module;
in response to the request to update, determine whether the replacement candidate is valid; and
in response to determining that the replacement candidate is not valid, prevent the update of the second software module with the replacement candidate.
